(19) United States
(12) Patent Application Publication
(10) Pub. No.: US 2020/0309182 A1
(43) Pub. Date: Oct. 1, 2020

(54) Screw

(71) Applicant: Drawlin Industry Co., Ltd., Sioushuei Township (TW)

(72) Inventor: Meng-Hsien Cheng, Sioushuei Township (TW)

(21) Appl. No.: 16/362,798

(22) Filed: Mar. 25, 2019

(51) Int. Cl. F16B 25/00; F16B 25/10

(52) U.S. Cl. CPC F16B 25/0084; F16B 25/103

(57) ABSTRACT

A screw contains: a head, a shank, and a tip. The head is configured to connect with a tool. The shank integrally extends from the head. The shank includes a screwing thread and a central axis. The tip is conical and includes a first segment and a second segment, wherein a diameter of the tip gradually decreases from the first segment to the second segment. The tip has a cone angle which is within 5 degrees to 30 degrees. The tip includes a conical drill portion having a pointed section away from the central axis. The tip further includes two chip elimination slots of different sizes, wherein two drilling edges are asymmetrical, and two cutting edges are asymmetric and are defined among the two chip elimination slots and the tip. The tip further includes a threaded guide section separated by the two chip elimination slots.

### BACKGROUND OF THE INVENTION

### Field of the Invention

The present invention relates to a screw which drills and cuts an object quickly and easily.

### Description of the Prior Art

A conventional screw is a fastener formed in a circular column shape and has threads so as to screw with an object by ways of the threads. The object has a threaded orifice corresponding to and screwing with the threads of the screw. In other words, the screw is drilled into the object so as to produce the threaded orifice on the object, and the threaded orifice is screwed with the screw.

The screw is made of different materials according to a type of the object. When the screw is drilled into and is screwed with the threaded orifice of the object, chips produces and are removed based on a screwing speed and a torque of the screw. For example, when the threads of the screw facilitate a removal of the chips, the screwing speed is quick and needed the torque is small. On the contrary, the screwing speed is slow and the resistance is large, when the threads of the screw do not facilitate the removal of the chips.

As illustrated in FIGS. 1 and 2, a conventional screw 90 contains: a head 91, a shank 92, and a tip 93.

The head 91 is configured to connect with a tool.

The shank 92 integrally extends from the head 91, and the shank 92 includes a screwing thread 921 surrounding around an outer wall of the shank 92.

The tip 93 is integrally formed on an end of the shank 92 away from the head 91 and is connected with the screwing thread 921 of the shank 92. The tip 93 includes a conical drilling portion 931 formed on a distal end thereof, wherein the conical drilling portion 931 has a pointed peak 9311 aligning with a central axis of the shank 92. The tip 93 includes two chip elimination slots 932 being symmetrical and extending from an outer wall of the tip 93 to the pointed peak 9311 of the conical drilling portion 931, wherein two symmetrical drilling edges 933 are defined among the two chip elimination slots 932 and the conical drilling portion 931, and the two symmetrical drilling edges 933 are connected with the pointed peak 9311, wherein two cutting edges 934 are symmetrical and are defined among the two chip elimination slots 932 and the tip 93.

As desiring to screw the screw 90 into the object, the pointed peak 9311 of the tip 93 of the screw 90 abuts against the object, the screw 90 is fitted with or is engaged with the head 91 of the screw 90 so that the tool actuates the screw 90 to rotate, then the pointed peak 9311 drills the object and the two symmetrical drilling edges 933 and the two cutting edges 934 of the tip 93 drill and cut the object, thus producing the chips. Thereafter, the chips are removed out of the two chip elimination slots 932 upward along the tip 93, and the screwing thread 921 is screwed with the object, thus screwing the screw 90 with the object.

However, the pointed peak 9311 aligns with the central axis of the shank 92, and the two chip elimination slots 932 are symmetrical, so a size of the two chip elimination slots 932 is limited to cause a poor removal of the chips after the screw 90 is screwed into the object, and a torque of screwing the screw 90 into the object is large, but a speed of screwing the screw 90 into the object is slow. In addition, the screw 90 is screwed into the object forcefully to damage the screw 90, and the screw 90 cannot be screwed into the object completely because of the poor removal of the chips.

The present invention has arisen to mitigate and/or obviate the afore-described disadvantages.

### SUMMARY OF THE INVENTION

The primary objective of the present invention is to provide a screw which is screwed into an object quickly and easily, and the chips are removed quickly.

Another objective of the present invention is to provide a screw which is not broken easily and is screwed into the object completely.

A screw provided by the present invention contains: a head, a shank, and a tip.

The head is configured to connect with a tool.

The shank integrally extends from the head, the shank includes a screwing thread surrounding around an outer wall of the shank, and the shank includes a central axis extending along a center of the shank.

The tip is integrally formed on an end of the shank away from the head, the tip includes a first segment arranged on a first end thereof close to the head, and the tip includes a second segment arranged on a second end thereof away from the head. The tip is conical, a diameter of the tip gradually decreases from the first segment to the second segment, and the tip has a cone angle which is within 5 degrees to 30 degrees. The tip includes a conical drill portion formed on a distal end thereof and having a pointed section formed on a distal end of the conical drill portion and being away from the central axis. The tip further includes two chip elimination slots of different sizes extending from an outer rim of the tip to the pointed section of the conical drill portion. Two drilling edges are asymmetric and are defined among the two chip elimination slots and the conical drill portion, and the two drilling edges are connected with the pointed section, wherein an included angle between the two drilling edges is within 60 degrees to 110 degrees, and the pointed section is away from the central axis, hence two lengths of the two drilling edges are not equal, and two cutting edges are asymmetric and are defined among the two chip elimination slots and the tip, the tip further includes a threaded guide section formed between the tip and the screwing thread of the shank, wherein the threaded guide section is separated by the two chip elimination slots.

### BRIEF DESCRIPTION OF THE DRAWINGS

FIG. 1 is a perspective view of a conventional screw.

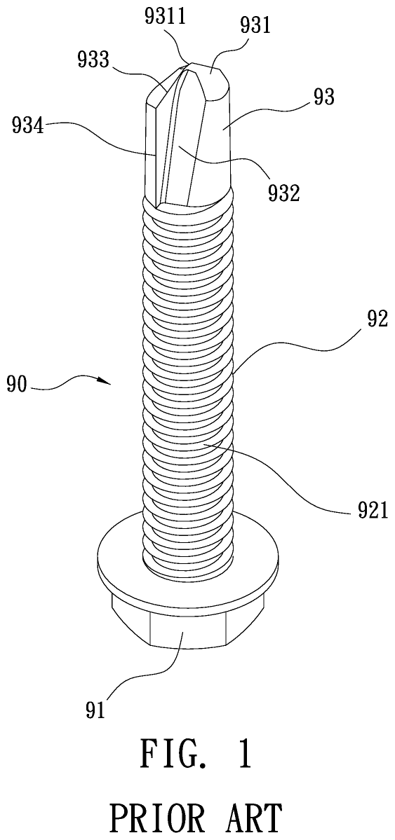

FIG. 2 is a side plan view of the conventional screw.

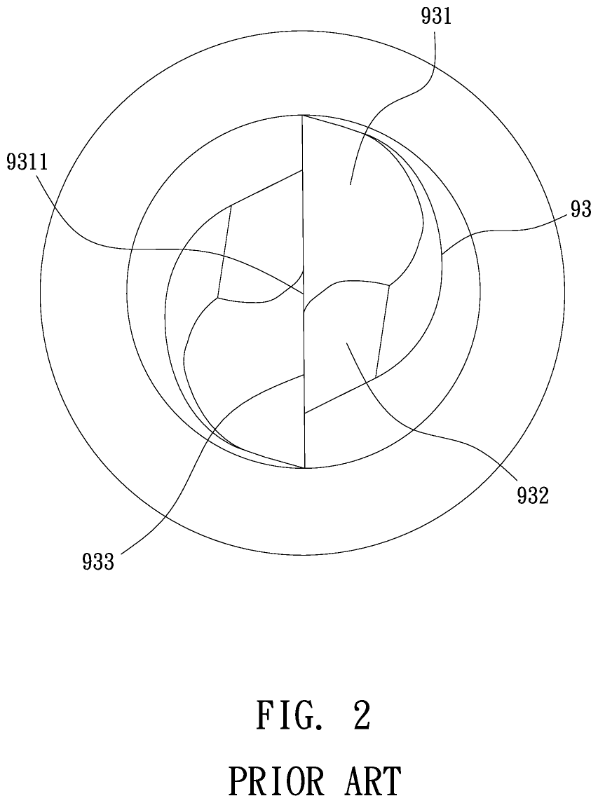

FIG. 3 is a perspective view showing the assembly of a screw according to a preferred embodiment of the present invention.

FIG. 4 is a side plan view showing the assembly of the screw according to the preferred embodiment of the present invention.

FIG. 5 is another side plan view showing the assembly of the screw according to the preferred embodiment of the present invention.

FIG. 6 is also another side plan view showing the assembly of the screw according to the preferred embodiment of the present invention.

FIG. 7 is still another side plan view showing the assembly of the screw according to the preferred embodiment of the present invention.

FIG. 8 is a cross sectional view showing the operation of the screw according to the preferred embodiment of the present invention.

FIG. 9 is another cross sectional view showing the operation of the screw according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

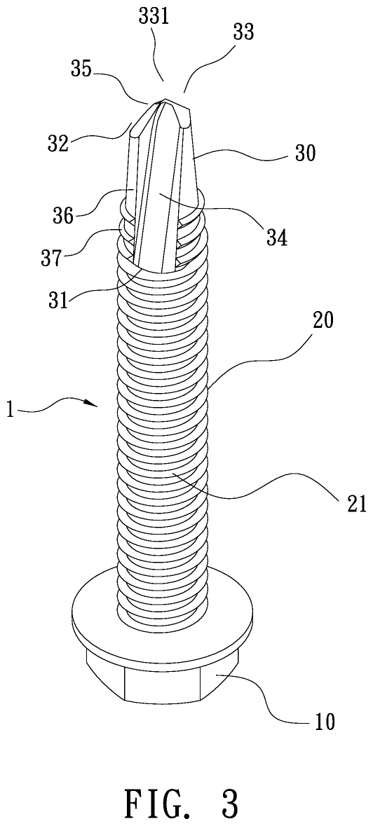

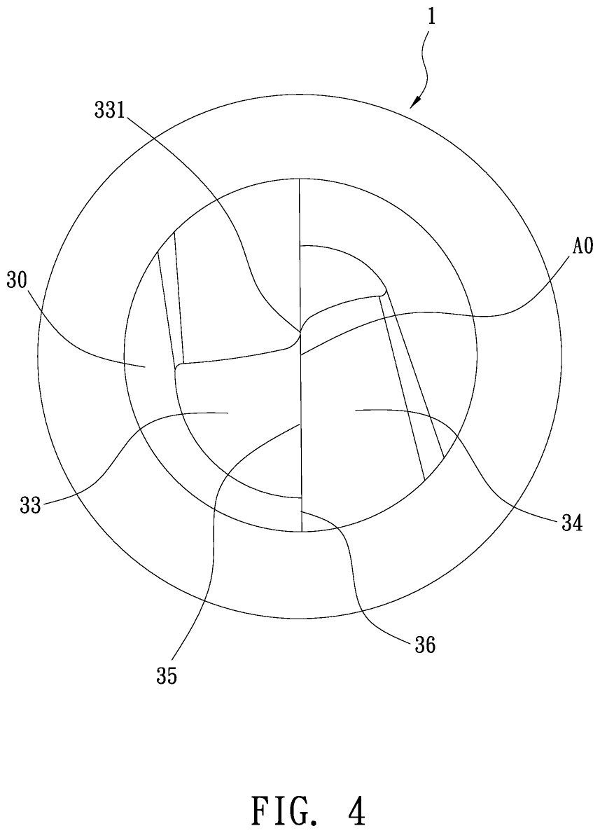

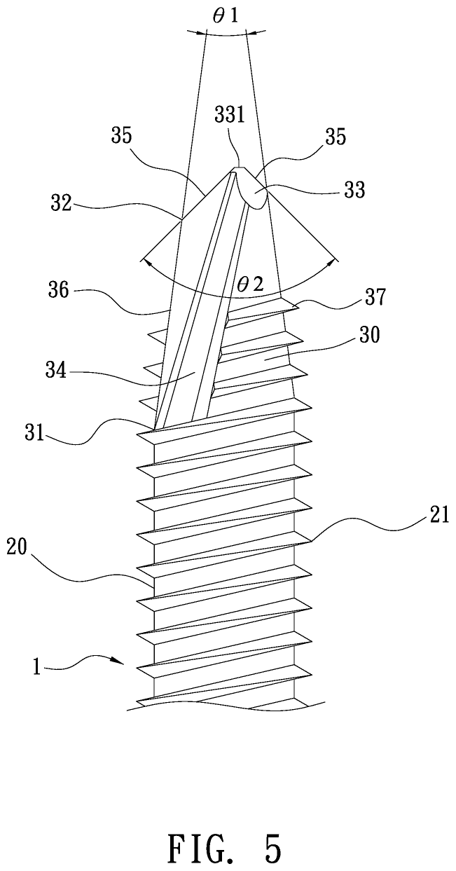

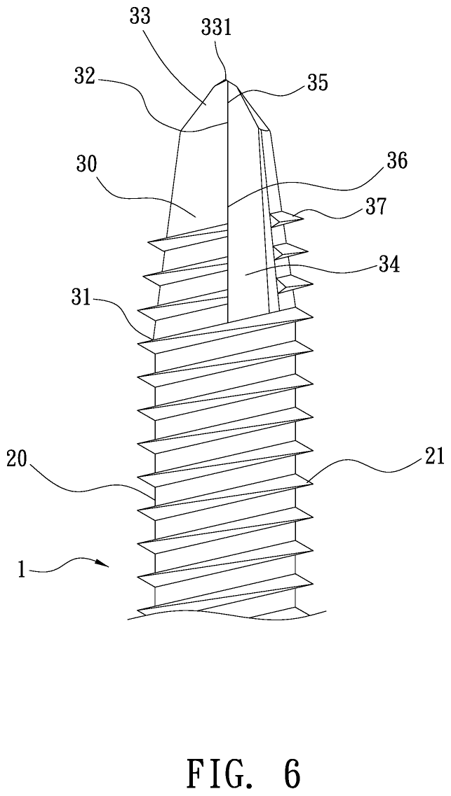

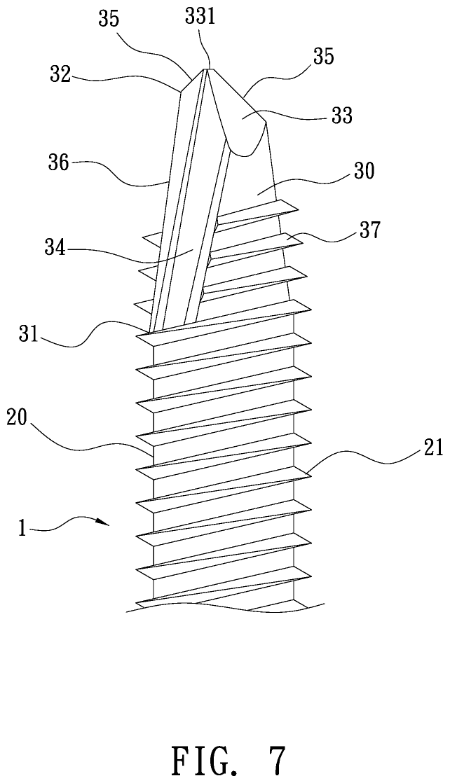

With reference to FIGS. 3-7, a screw 1 according to a preferred embodiment of the present invention comprises: a head 10, a shank 20, and a tip 30.

The head 10 is configured to connect with a tool.

The shank 20 integrally extends from the head 10, the shank 20 includes a screwing thread 21 surrounding around an outer wall of the shank 20, and the shank 20 includes a central axis A0 extending along a center of the shank 20.

The tip 30 is integrally formed on an end of the shank 20 away from the head 10, the tip 30 includes a first segment 31 arranged on a first end thereof close to the head 10, and the tip 30 includes a second segment 32 arranged on a second end thereof away from the head 10, wherein the tip 30 is conical (i.e., a diameter of the tip 30 gradually decreases from the first segment 31 to the second segment 32), the tip 30 has a cone angle θ1 which is within 5 degrees to 30 degrees (in this embodiment, the cone angle θ1 is 15 degrees). The tip 30 includes a conical drill portion 33 formed on a distal end thereof and having a pointed section 331 formed on a distal end of the conical drill portion 33 and being away from the central axis A0. The tip 30 further includes two chip elimination slots 34 of different sizes extending from an outer rim of the tip 30 to the pointed section 331 of the conical drill portion 33, wherein two drilling edges 35 are asymmetric and are defined among the two chip elimination slots 34 and the conical drill portion 33, and the two drilling edges 35 are connected with the pointed section 331, wherein an included angle θ2 between the two drilling edges 35 is within 60 degrees to 110 degrees (in this embodiment, the included angle θ2 is 90 degrees), and the pointed section 331 is away from the central axis A0, hence two lengths of the two drilling edges 35 are not equal, and two cutting edges 36 are asymmetric and are defined among the two chip elimination slots 34 and the tip 30. The tip 30 further includes a threaded guide section 37 formed between the tip 30 and the screwing thread 21 of the shank 20, wherein the threaded guide section 37 is separated by the two chip elimination slots 34.

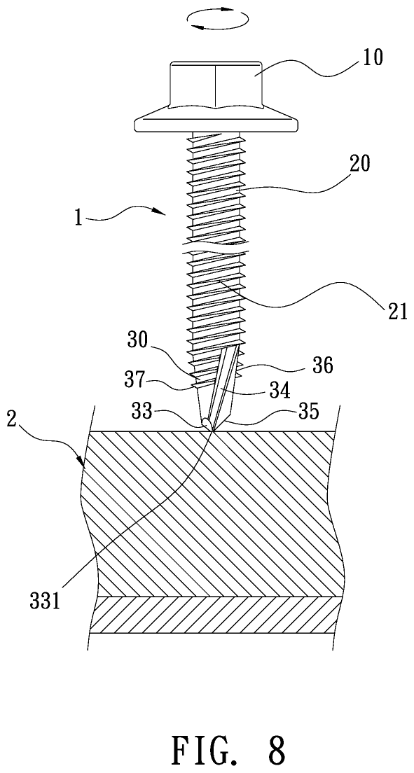

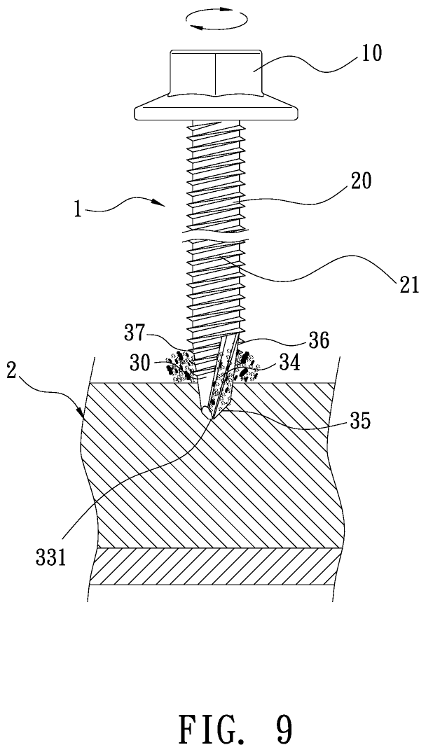

Referring to FIGS. 8 and 9, as desiring to screw the screw 1 into an object 2, the pointed section 331 of the tip 30 of the screw 1 abuts against the object 2 so that the tool is fitted or engaged with the head 10 of the screw 1, and the tool actuates the screw 1 to rotate so that the pointed section 331 drills and cuts the object 2. After the pointed section 331 is drilled into the object 2, the two drilling edges 35 and the two cutting edges 36 of the tip 30 drill and cut the object 2, thus producing chips. Thereafter, the chips are removed from the tip 30 along the two chip elimination slots 34, and the threaded guide section 37 and the screwing thread 21 of the shank 20 are screwed into the object 2, thus screwing the screw 1 with the object 2 quickly and easily.

Thereby, the screw 1 of the present invention has advantages as follow:

The pointed section 331 is away from the central axis A0, the tip 30 is conical, the two drilling edges 35 and the two cutting edges 36 are asymmetric, and two sizes of the two chip elimination slots 34 are different so that the cone angle θ1 is within 5 degrees to 30 degrees, and the included angle θ2 is within 60 degrees to 110 degrees, hence the screw 1 is screwed into the object 2 quickly and easily, and the chips are removed quickly. Furthermore, the screw 1 is not broken easily and is screwed into the object 2 completely.

While various embodiments in accordance with the present invention have been shown and described, it is clear to those skilled in the art that further embodiments may be made without departing from the scope of the present invention.

What is claimed is:

1. A screw comprising:
a head configured to connect with a tool;
a shank integrally extending from the head, the shank including a screwing thread surrounding around an outer wall of the shank, and the shank including a central axis extending along a center of the shank; and
a tip integrally formed on an end of the shank away from the head, the tip including a first segment arranged on a first end of the tip close to the head, and the tip including a second segment arranged on a second end of the tip away from the head, wherein the tip is conical, a diameter of the tip gradually decreases from the first segment to the second segment, the tip has a cone angle which is within 5 degrees to 30 degrees, and the tip includes a conical drill portion formed on a distal end thereof and having a pointed section formed on a distal end of the conical drill portion and being away from the central axis, the tip further includes two chip elimination slots of different sizes extending from an outer rim of the tip to the pointed section of the conical drill portion, wherein two drilling edges are asymmetric and are defined among the two chip elimination slots and the conical drill portion, and the two drilling edges are connected with the pointed section, wherein an included angle between the two drilling edges is within 60 degrees to 110 degrees, and the pointed section is away from the central axis, hence two lengths of the two drilling edges are not equal, and two cutting edges are asymmetric and are defined among the two chip elimination slots and the tip, the tip further includes a threaded guide section formed between the tip and the screwing thread of the shank, wherein the threaded guide section is separated by the two chip elimination slots.

2. The screw as claimed in claim 1, wherein the cone angle is 15 degrees.

3. The screw as claimed in claim 1, wherein the included angle is 90 degrees.
